(19) United States
(12) Patent Application Publication
(10) Pub. No.: US 2007/0025215 A1
(43) Pub. Date: Feb. 1, 2007

(54) Disk reproducing device provided with pickup lens dirt detection function

(75) Inventors: Fumio Kinoshita, Echizen-city (JP); Masahiko Nishide, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/492,947

(22) Filed: Jul. 26, 2006

(30) Foreign Application Priority Data
Jul. 28, 2005 (JP) 2005-219362

(51) Int. Cl. G11B 27/36; G11B 20/18

(52) U.S. Cl. 369/53.15; 369/53.35

(57) ABSTRACT

The invention provides a disk reproducing device capable of automatically detecting dirt on a lens without using any additional members. A pickup unit 5 reads a video signal of a storage medium 2, comparison/judgment means 9a compares an attenuation ratio of an RF signal B amplified by an RF amplifier section 8 to a standard RF signal A stored in a storage section 12 with a threshold P likewise stored in the storage section 12 and judges that there is dirt on a pickup lens 51 when the comparison value falls below the threshold P, and a display section 11 displays alarm message data 122 stored in the storage section 12 superimposed on images being reproduced, and it is possible to thereby automatically detect dirt on the pickup lens 51 and report it to the user.

The present application is based on and claims priority of Japanese patent application No. 2005-219362 filed on Jul. 28, 2005, the entire contents of which are hereby incorporated by reference.

### BACKGROUND OF THE INVENTION

1. Field of the Invention

The present invention relates to a disk reproducing device provided with a pickup lens, and more particularly, to a disk reproducing device provided with a pickup lens dirt detection function configured so as to alarm and display about dirt on a pickup lens.

2. Description of the Related Art

Conventionally, a disk reproducing device has a pickup lens to read a signal for reproduction, emits a laser beam onto an inserted storage medium, receives the laser beam reflected from the storage medium and thereby reads a signal on the storage medium. However, because of dirt or dust stuck to this pickup lens, errors may occur when reading the storage medium and to automatically detect these reading errors, various methods are disclosed.

For example, Japanese Patent Laid-Open Publication No. 7-14214 (Patent Document 1) discloses a method whereby an optical disk having a plurality of areas with different transmittances is used to reproduce data on the optical disk, the degree of dirt on the pickup unit is detected and reported based on its reflectance.

Furthermore, Japanese Patent Laid-Open Publication No. 2004-39189 (Patent Document 2) discloses a method whereby a member for detecting light output is disposed at a position facing a light-emitting section with a pickup lens placed in between, the degree of attenuation of the laser beam from the light-emitting section by the pickup lens is examined, the attenuation is compared with an output level stored beforehand in a storage device and when the pickup lens is judged to be dirty, that judgment is reported.

However, the methods disclosed in Patent Documents 1 and 2 require the use or installation of additional parts or members, which may cause an increase in manufacturing cost.

### SUMMARY OF THE INVENTION

The present invention has been implemented in view of the above described problems and it is an object of the present invention to provide a disk reproducing device provided with a pickup lens dirt detection function for automatically detecting dirt on the pickup lens without using any dedicated medium or external device.

The disk reproducing device provided with a pickup lens dirt detection function according to a first aspect of the present invention comprises a pickup unit which is provided with at least a pickup lens for reproducing information stored in a storage medium, causes the storage medium to reflect a laser beam irradiated from the pickup lens and generates an RF (Radio Frequency) signal from the reflected laser beam, signal amplification means for amplifying the RF signal, storage means for storing a standard RF signal to be compared with the RF signal and various parameters such as a threshold, and control means provided with comparison/judgment means for comparing the RF signal and the standard RF signal for controlling the operation of the disk reproducing device, wherein it is judged whether the RF signal is attenuating or not based on the comparison value obtained from the comparison/judgment means and an alarm is displayed on a display section or display device when the comparison value falls below the threshold.

According to the construction of the first aspect of the present invention, when video data or the like stored in the storage medium is read, the RF signal generated by the pickup unit and amplified by the signal amplification means is compared with the standard RF signal stored beforehand in the storage means, and if considerable attenuation is observed in the RF signal, it is judged that there is trouble inside the pickup unit or storage medium and an alarm is displayed indicating the occurrence of the trouble.

The disk reproducing device provided with a pickup lens dirt detection function according to a second aspect of the present invention is the disk reproducing device provided with a pickup lens dirt detection function according to the first aspect of the present invention, wherein the disk reproducing device further comprises timer count means for temporarily storing the number of times the comparison/judgment means performs operation of judging attenuation of the RF signal and displays different alarms depending on the number of times judging operation is performed.

According to the construction of the second aspect of the present invention, when attenuation of the RF signal is confirmed by the comparison/judgment means, the trouble can be judged step by step, for example, by displaying an alarm about a possibility of dirt on the pickup lens for the first time and displaying an alarm about a possibility of dirt or distortion of the disk which is the storage medium for the second time.

The disk reproducing device provided with a pickup lens dirt detection function according to a third aspect of the present invention is the disk reproducing device provided with a pickup lens dirt detection function according to the first or second aspect of the present invention, wherein a comparison between the RF signal and the standard RF signal is made by comparing the gain widths when both frequency waveforms have maximum amplitude.

According to the construction of the third aspect of the present invention, the standard RF signal stored beforehand in the storage means is compared in gain widths with the RF signal generated when data is read from the storage medium when the respective signals have maximum amplitude, and it is possible to thereby reliably judge attenuation of the signal and judge trouble with the pickup lens and storage medium.

The disk reproducing device provided with a pickup lens dirt detection function according to a fourth aspect of the present invention is the disk reproducing device provided with a pickup lens dirt detection function according to any one of the first to third aspects of the present invention, wherein the storage means stores display data or the like to OSD (On Screen Display) display an alarm message indicating dirt on the pickup lens and OSD-displays an alarm message on the display section or display device when the comparison value obtained by the comparison/judgment means falls below the threshold.

According to the construction of the fourth aspect of the present invention, OSD display data indicating alarm messages is stored beforehand in the storage means and when the comparison/judgment means has trouble reading the signal of the storage medium, it is possible to thereby display an alarm message about a possible cause to the user.

### BRIEF DESCRIPTION OF THE DRAWINGS

FIG. 1 is a block diagram showing the construction of a disk reproducing device which is an embodiment of the present invention;

FIG. 2 is a flow chart showing the operation of the disk reproducing device according to the embodiment of the present invention;

FIG. 3 is a flow chart showing the operation of the disk reproducing device according to the embodiment of the present invention;

FIG. 4 is a flow chart showing the operation of the disk reproducing device according to the embodiment of the present invention;

FIG. 5 is a flow chart showing the operation of the disk reproducing device according to the embodiment of the present invention;

FIG. 6 flow chart showing the operation of the disk reproducing device according to the embodiment of the present invention;

FIG. 7 illustrates an alarm message OSD suggesting cleaning of the pickup lens displayed on the display section according to the embodiment of the present invention;

FIG. 8 illustrates an alarm message OSD suggesting cleaning of the inserted storage medium according to the embodiment of the present invention;

FIG. 9 illustrates an alarm message OSD indicating an error of the inserted storage medium according to the embodiment of the present invention;

FIG. 10 illustrates an alarm message OSD indicating an error of the disk reproducing device itself according to the embodiment of the present invention; and

FIG. 11 illustrates an example of the waveform of an RF signal according to the embodiment of the present invention.

### DETAILED DESCRIPTION OF THE PREFERRED EMBODIMENTS

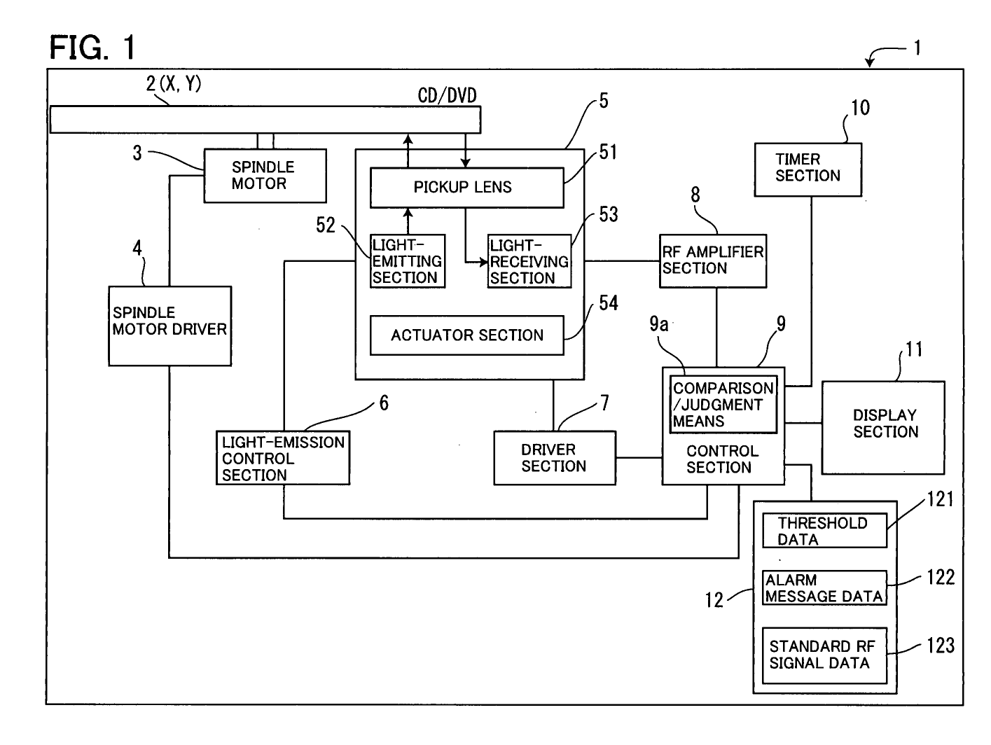

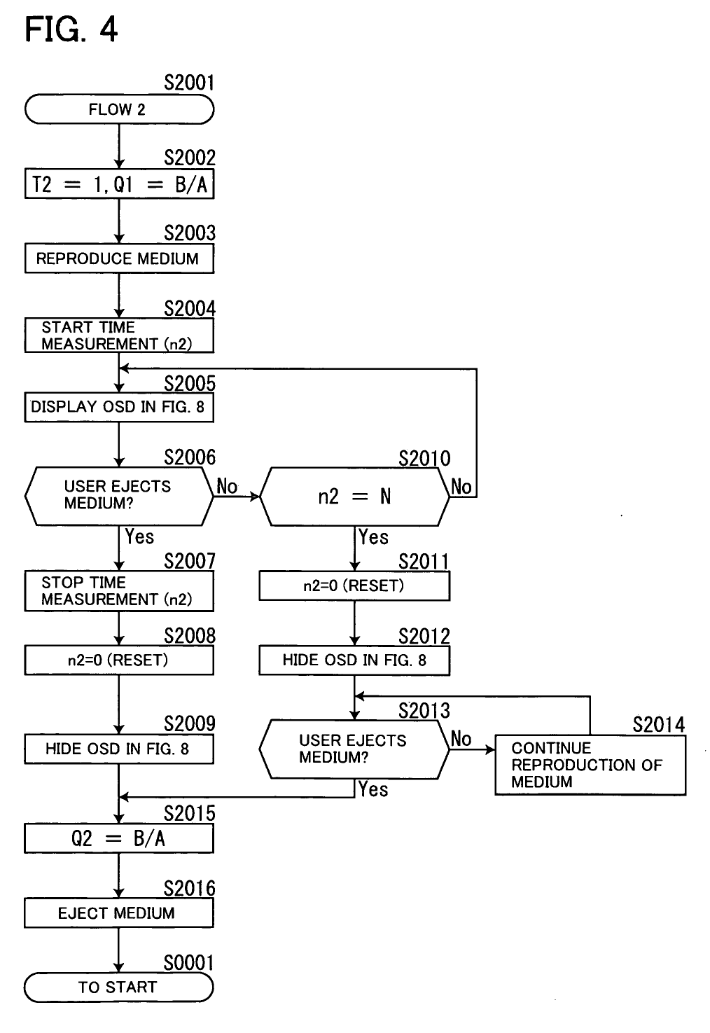

Hereinafter, as the best mode for implementing the present invention, an embodiment will be explained with reference to FIG. 1 to FIG. 11. It goes without saying that the present invention is also easily applicable to cases other than that explained in the embodiment within a range not departing from the essence of the present invention.

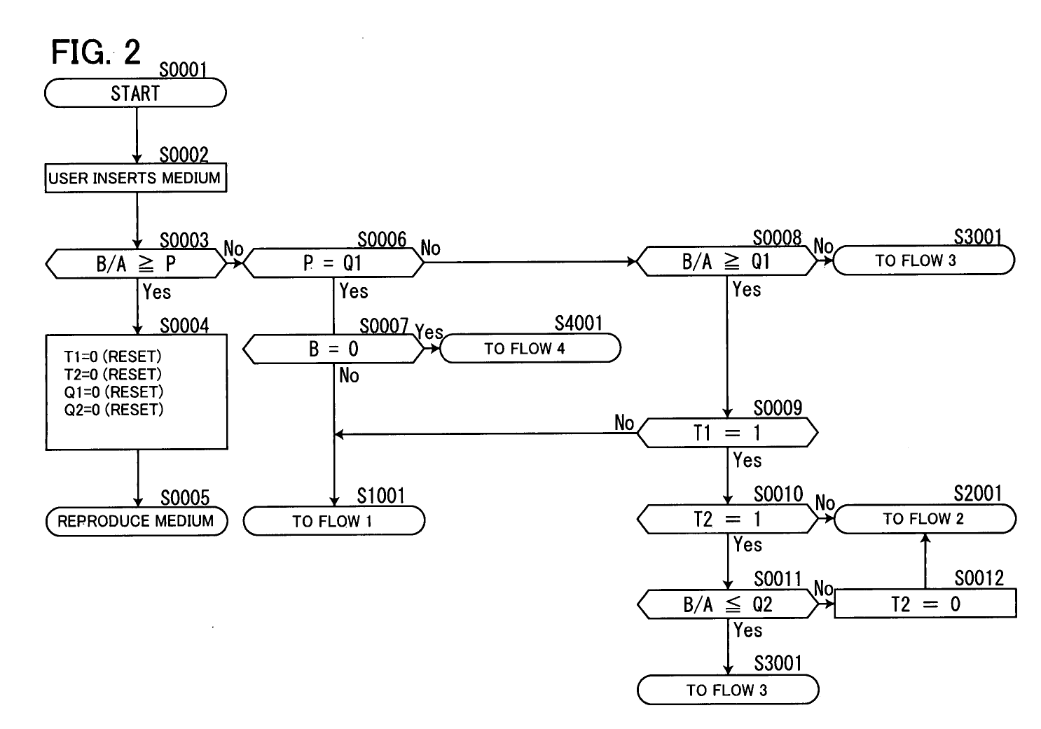

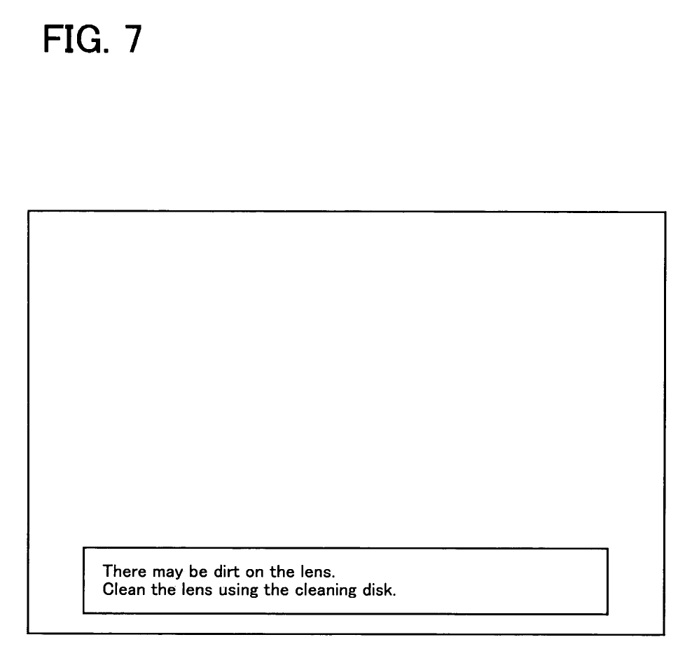

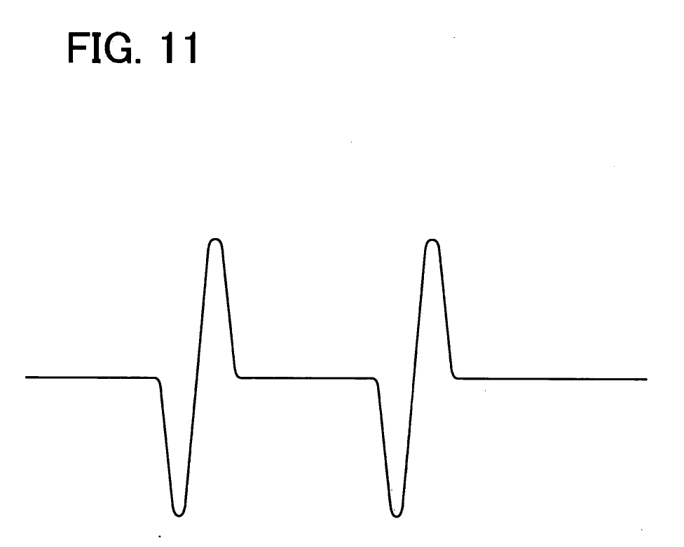

FIG. 1 to FIG. 11 show an embodiment of the present invention and FIG. 1 is a block diagram showing the construction of the disk reproducing device in this embodiment. FIGS. 2 to 6 are flow charts showing the operation of the lens dirt detection function of the disk reproducing device. FIGS. 7 to 10 illustrate alarm messages displayed on the display section or display device. FIG. 11 illustrates the waveform of an RF signal.

The construction of the disk reproducing device of this embodiment will be explained based on FIG. 1. Reference numeral 1 denotes a disk reproducing device. Reference numeral 2 denotes a storage medium inserted such as CD (Compact Disk) or DVD (Digital Versatile Disk). Reference numeral 3 denotes a spindle motor to rotate the storage medium 2 and 4 denotes a spindle motor driver which controls rotation and stoppage of the spindle motor. Reference numeral 5 denotes a pickup unit, which is made up of a pickup lens 51, a light-emitting element (not shown), a light-emitting section 52 which irradiates a laser beam, a light-receiving element (not shown), a PDIC (Photo Direct Integrated Circuit), a light-receiving section 53 which converts the received laser beam to an RF signal and an actuator section 54 to drive the pickup unit 5. Reference numeral 6 denotes a light-emission control section, which receives an instruction from a control section which will be described later and controls the light-emitting section 52. Reference numeral 7 denotes a driver section, which controls the operation of the actuator section 54 according to an instruction from a control section which will be described later. Reference numeral 8 denotes an RF amplifier section, which is signal amplification means for amplifying an RF signal generated by converting the laser beam through the light-receiving section 53. Reference numeral 9 denotes a control section, which is control means for controlling the disk reproducing device 1 and 9a denotes comparison/judgment means for carrying out operation of detecting trouble of the pickup unit 5 or storage medium through a comparison of the RF signal. Reference numeral 10 denotes a timer section, which is time counting means for temporarily storing parameters when a trouble detection function is in operation. Reference numeral 11 denotes a display section or display device, which displays images reproduced by a disk reproducing device or performs an OSD display. Reference numeral 12 denotes a storage section, which is storage means for storing OSD display data of thresholds and alarm messages or the like.

Next, based on FIGS. 2 to 7, the operation of the pickup lens dirt detection function of the disk reproducing device 1 will be explained. The following reference characters will be used to explain this embodiment. Note that numerical values such as initial values given to the following reference characters are values for convenience to define points of the present invention and facilitate an understanding of explanations of this embodiment and not intended to confine the present invention to these values. Reference character P denotes a threshold to be compared with a ratio of a maximum amplitude of RF signal B with respect to a maximum amplitude of standard RF signal A (hereinafter referred to as “B/A”) and suppose the initial value is 70 (the unit is %). Reference character N denotes an alarm message display time and suppose the initial value is 15 (the unit is seconds). Reference characters T1, T2 each denote a time count for counting the number of times a predetermined location is passed in a flow chart and suppose the respective initial values are 0 (the unit is the number of times). Reference characters Q1, Q2 each denote a storage value which stores the maximum amplitude of RF signal B/maximum amplitude of standard RF signal A at a predetermined location in the flow chart and suppose their initial values are 70 and 0 respectively (the unit is %). Note that an RF signal generated with the reproduction of a storage medium has the waveform as shown in FIG. 11.

Next, the operation of the comparison/judgment means 9a will be explained as cases 1 to 5. First, case 1 where there is no trouble in the pickup lens 51 or storage medium 2 and the value of B/A is 75% will be explained. In this case, suppose the storage medium is loaded for the first time (S0001). The user loads the storage medium 2 such as a disk in the device (S0002). The maximum amplitude of the standard RF signal A is compared with the maximum amplitude of the RF signal B of the storage medium 2 and the comparison result is judged as to whether or not to exceed the threshold P (S0003). In this case, B/A is 75%, which exceeds the value of the threshold P and both the pickup unit and storage medium 2 are judged to have no problem. The storage values Q1, Q2 and time counts T1, T2 are reset to initial set values (S0004) and reproduction of the storage medium 2 is performed as usual.

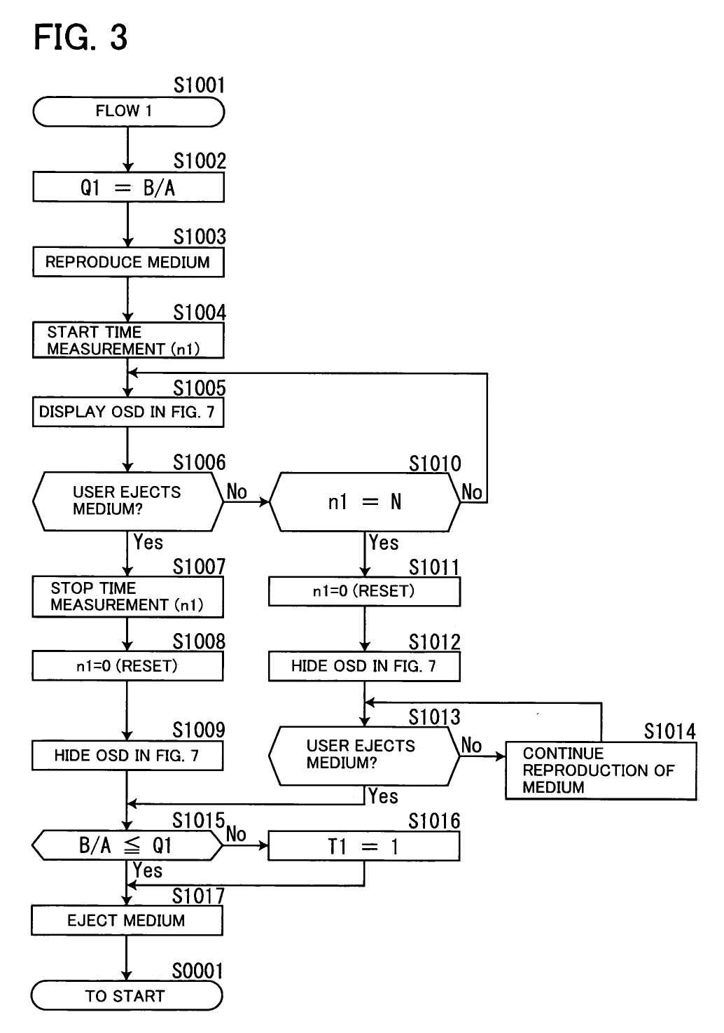

Next, case 2 where there is trouble with the pickup lens 51 or storage medium 2 and the value of B/A is 60% will be explained. In this case in the same way as case 1, suppose the storage medium is loaded for the first time (S0001). The user loads the storage medium 2 such as a disk in the device (S0002). B/A is compared and judged as to whether or not to exceed the threshold P (S0003). In this case, since B/A=60%, this falls below the value of the threshold P and any one or both of the pickup unit 5 and storage medium 2 is/are considered to have trouble, and therefore the process moves to step S0006. It is judged whether the threshold P and storage value Q1 have the same value or not (S0006). As the initial settings, both the threshold P and storage value Q1 are set to 70% and there are no fluctuations, and therefore the process moves to step S0007. It is judged whether the maximum amplitude of the RF signal B from the storage medium 2 is 0 or not (S0007) and if the maximum amplitude of the RF signal B≠0, the process moves to S1001 in the flow chart shown in FIG. 3. A case where the maximum amplitude of the RF signal B is 0 will be explained later.

In the flow chart 1 shown in FIG. 3, the value of B/A is substituted into the storage value Q1 (S1002). In this case, since B/A (60% in this case) is substituted into the storage value Q1, the storage value Q1 is changed from the initial set value 70% to 60%. Next, the storage medium 2 is reproduced (S1003). Next, time measurement for measuring a period during which an alarm message OSD is displayed is performed (S1004). Suppose this time measurement is n1 and the count is incremented every one second. Then, an alarm message OSD on the display section 11 suggesting cleaning of the pickup lens 51 as shown in FIG. 7 is read from the alarm message data 122 of the storage section 12, displayed superimposed on the video being reproduced (S1005). While an alarm message OSD is being displayed, if the user judges whether or not to eject the storage medium 2 (S1006) and instructs an ejection, time measurement n1 is stopped (S1007), time measurement n1 is reset (S1008) and the alarm message OSD is stopped (S1009). Furthermore, when the user does not instruct the ejection of the storage medium 2 in S1008, reproduction of the video is continued until the time measurement n1 reaches the initial set value N (15 seconds) (S1010) and when the time measurement n1 becomes N, the time measurement n1 is reset (S1011), the display of the alarm message OSD is stopped (S1012) and the reproduction of the storage medium 2 is continued (S1014) until the user ejects the storage medium 2 (S1013). After the processing in step S1009 or after the ejection of the storage medium 2 is instructed in step S1013, it is judged whether B/A≦Q1 or not (S1015). In this case, if it is assumed that the value of B/A is not improved during the reproduction and B/A is 60%, then B/A becomes Q1 and time count T1 remains 0 and the storage medium 2 is ejected (S1017).

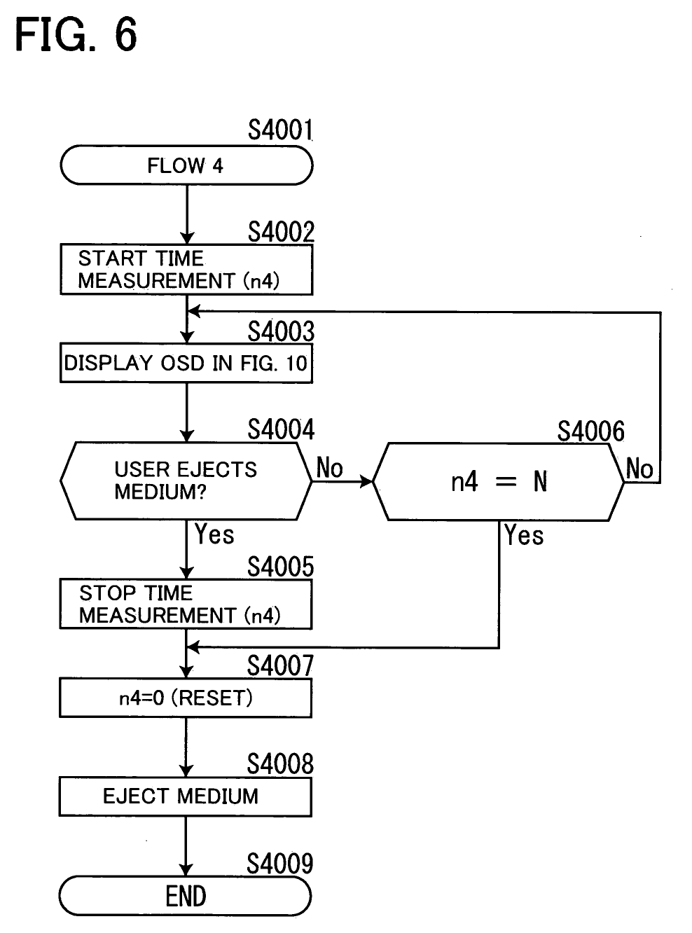

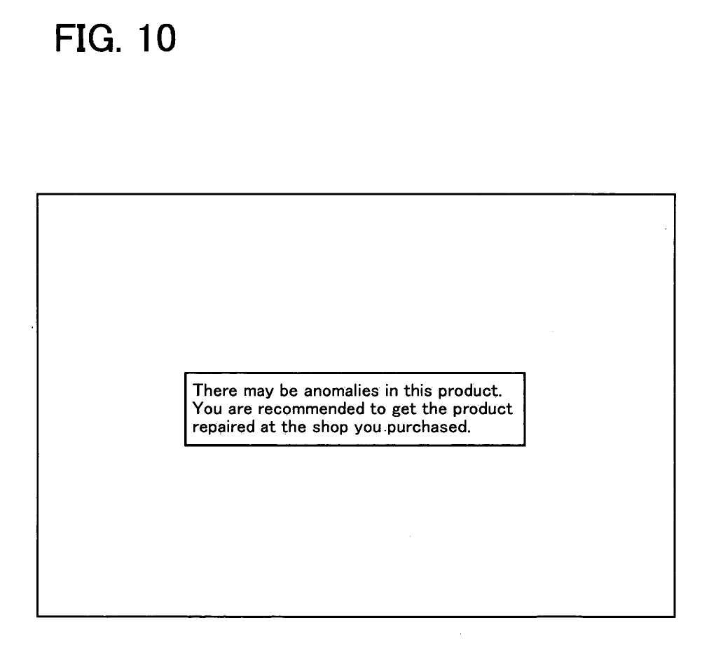

Furthermore, in step S0007, when the maximum amplitude of the RF signal B from the storage medium 2 is judged to be 0, this obviously indicates trouble with the pickup unit 5, and therefore the process moves to the flow chart 4 shown in FIG. 6 (S4001). First, time measurement n4 is started and the count is incremented every one second (S4002). Next, an alarm message OSD as shown in FIG. 10 is displayed on the display section 11 reporting that an error has occurred in the disk reproducing device 1 (S4003). While the alarm message OSD is being displayed, it is judged whether or not the user instructs an ejection of the storage medium 2 (S4004) and if the ejection is instructed, time measurement n4 is stopped (S4005), and when the ejection of the storage medium 2 is not instructed, the display of the alarm message OSD is continued until the time measurement n4=N (15 seconds) elapses (S4006). After the process of stopping the time measurement n4 is performed in step S4005 or when the time measurement n4 reaches N in step S4006, the time measurement n4 is reset (S4007) and the storage medium 2 is ejected. That is, when the storage medium 2 is forcibly ejected even if the user does not instruct an ejection of the storage medium 2.

Following the above described case 2, case 3 where a cleaning medium X is inserted after ejecting the storage medium 2 will be explained. Suppose B/A by the cleaning medium X is 65%. In this case, the medium is inserted for the second time assuming the insertion of the storage medium 2 in the above described case 2 as the first time (S0001). The cleaning medium X is inserted (S0002). When B/A=65% is compared with the threshold P, B/A falls below the threshold P by 5%, and therefore the value stored in the storage value Q1 is compared with the threshold P (S0006). In this case, the threshold P=70% and 60% is substituted into the storage value Q1 in the preceding case 2, and therefore the process moves to step S0008. Here, it is judged whether B/A exceeds the storage value Q1 or not (S0008) and since B/A=65%, Q1=60% in this case, the process moves to step S0009. Next, it is judged whether the time count T1 is 1 or not (S0009). Here, since time count T1=0 in the preceding case, the process moves to step S1001. Details of the operation when time count T1=1 will be explained in the explanation of case 4. The operation in and after step S1001 is substantially the same as that in the preceding case 2, and therefore explanations of S1002 to S1015 will be omitted. Since the value of B/A improves by reproducing the cleaning medium X, B/A>Q1 in S1015 and 1 is substituted into the time count T1 (S1016) and the cleaning medium X is ejected (S1017).

Case 4 following the above described case 3 where the storage medium 2 is reinserted will be explained. Suppose the value of B/A has improved to 68% with the reproduction of the cleaning medium X in case 3. In the case 2, the value of the threshold P may be actually exceeded and in such a case, the operation in the case 1 is performed. In this case, the operation is started with values changed to storage value Q1=65%, time count T1=1 (S0001). The storage medium 2 inserted in case 2 is inserted (S0002). B/A is compared with the threshold P (S0003). In this case, since B/A=68% is assumed, the process moves to step S0006, step S0008 in the same way as case 3, and in step S0009 it is judged whether the value of the time count T1 is 1 or not. In preceding case 3, 1 is substituted into the time count T1, and therefore the process moves to the next step, and the value substituted into the time count T2 is judged (S0010). Since the time count T2 is 0, which is an initial value, the process moves to step S2001.

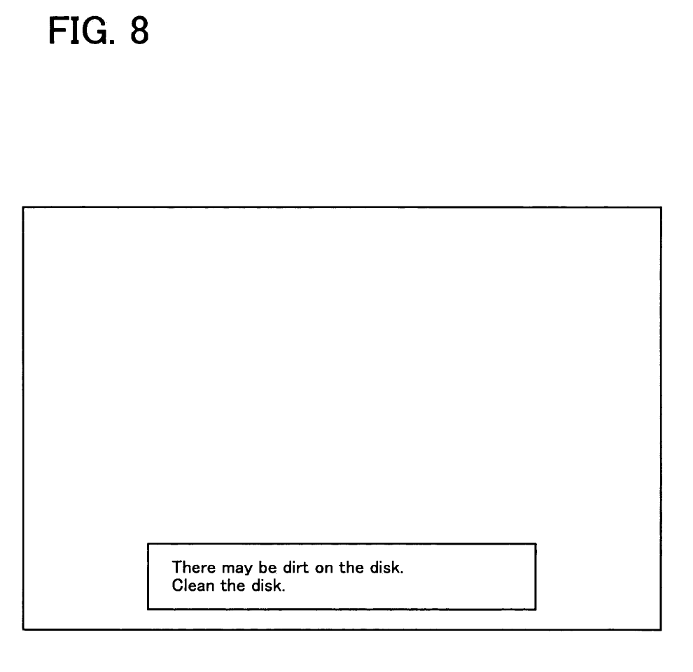

Next, time count T2=1, storage value Q1=B/A are set respectively (S2002). The inserted storage medium 2 is reproduced (S2003) and the time measurement n2 is incremented every one second (S2004). An alarm message OSD suggesting cleaning of the disk itself as shown in FIG. 8 is read from the alarm message data 122 of the storage section 12 and displayed superimposed on the display section 11 (S2005), urging the user to eject the storage medium 2 being reproduced. When the user instructs an ejection of the storage medium 2 while the alarm message OSD is being displayed (S2006), the time measurement n2 is stopped (S2007), the time measurement n2 is reset (S2008) and the display of the alarm message OSD is stopped (S2009). On the other hand, when the user does not instruct an ejection of the storage medium 2, the alarm message OSD is displayed until the time measurement n2=N (15 seconds) (S2010) and when time measurement n2=N, the time measurement n2 is reset (S2011) and the display of the alarm message OSD is stopped (S2012). Then, the reproduction of the storage medium 2 is continued (S2014) until the user instructs an ejection of the storage medium 2 (S2013). When the display of the alarm message OSD is stopped in step S2009 or the ejection of the storage medium 2 is instructed by the user in step 2013, B/A is substituted into the storage value Q2 (S2015) and the storage medium 2 is ejected (S2016).

Next, case 5 where the user performs cleaning of the storage medium 2 following an alarm message in the case 4 and inserts it in the disk reproducing device 1 for the third time will be explained. Suppose the value of B/A is not improved and remains 68% though cleaning of the storage medium 2 has been performed. At this time, values have been changed to storage value Q1=Q2=68%, time count T1=T2=1 until case 4 (S0001). The cleaned storage medium 2 is inserted by the user (S0002). According to the value of B/A and storage value Q1, the process moves to step S0003, step S0006, step S0008 and step S0009 in succession. The details of the operation are the same as those of the operation in the aforementioned cases 1 to 4, and therefore explanations thereof will be omitted. It is judged whether time count T2=1 or not (S0010) and since T2=1, the process moves to step S0011. Then, it is judged whether B/A≦Q2 or not (S0011). In this case, since B/A=68% and storage value Q2=68%, the process moves to step S3001.

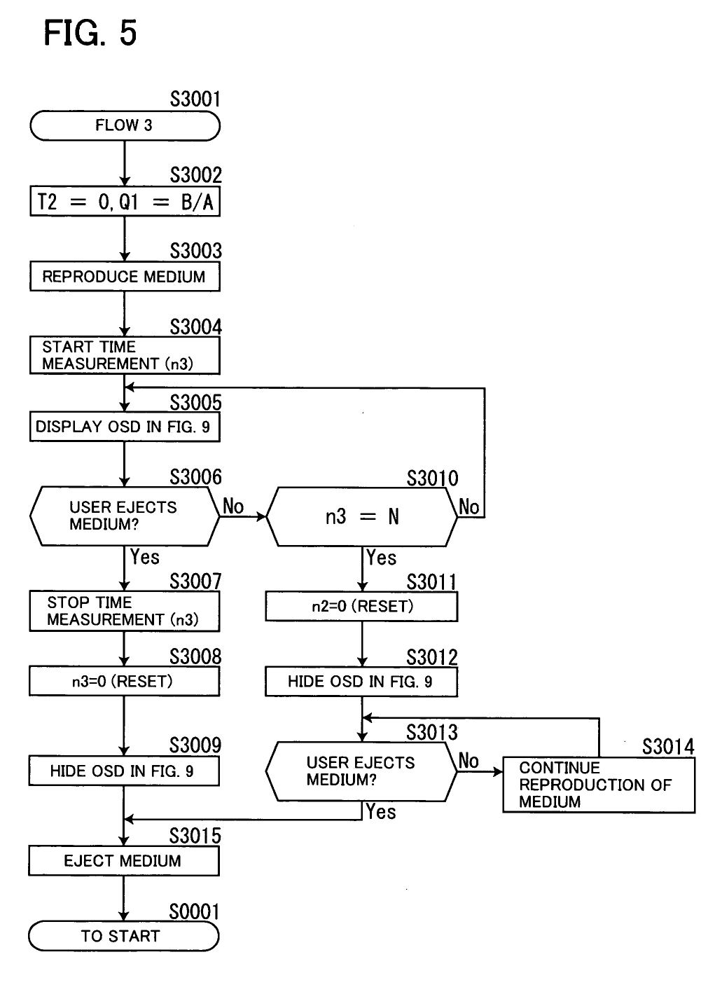

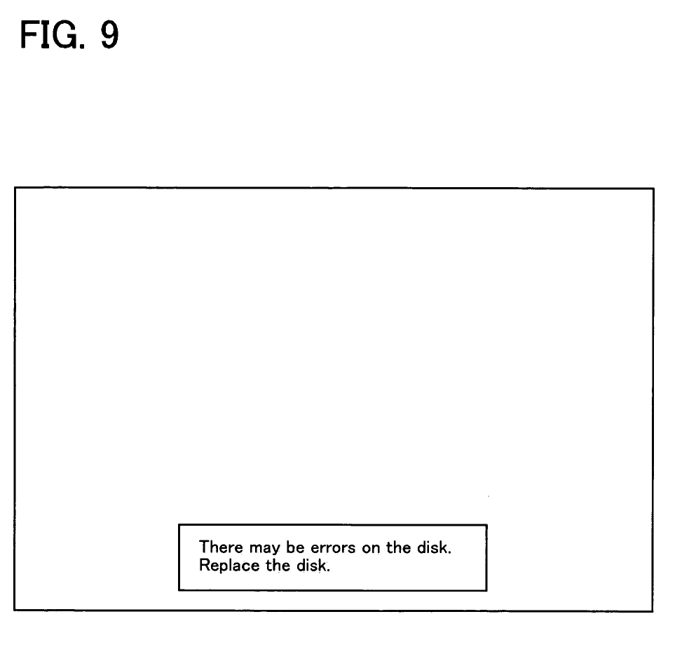

In the flow chart shown in FIG. 5, the time count T2 is changed from 1 to 0 and the storage value Q1 is changed to B/A (68%), which is the value of a comparison with the RF signal of the storage medium 2 currently being inserted (S3002). The storage medium 2 is reproduced (S3003), a time measurement n3 is started and the count is incremented every one second (S3004). Next, an alarm message OSD indicating an error of the disk itself as shown in FIG. 9 is read from the alarm message data 122 of the storage section 12 and displayed superimposed on the video image being reproduced on the display section 11 (S3005). It is judged whether the user has instructed an ejection of the storage medium 2 or not (S3006), and if the user ejects it, the time measurement n3 is stopped (S3007), the time measurement n3 is reset (S3008) and the display of the alarm message OSD is stopped (S3009). Here, if the user does not instruct the ejection of the storage medium 2 in step S3006, the display of the alarm message OSD is continued until the time measurement n3=N (15 seconds) (S3010), the time measurement n3 is reset when the time measurement n3 becomes N and the display of the alarm message OSD is stopped (S3012). Then, the reproduction of the video stored in the storage medium 2 is continued (S3014) until the user instructs an ejection of the storage medium 2 (S3013). After the display of the alarm message OSD is stopped in step S3009 or after the user instructs an ejection of the storage medium 2 in step S3013, the storage medium 2 is ejected from the disk reproducing device 1 (S3015).

After recognizing in case 5 that trouble has occurred in the inserted storage medium 2, a case 6 where the user performs reproduction using a storage medium Y which is a different storage medium whose B/A is assumed to be 75% will be explained. Before the storage medium Y is inserted, the storage values Q1 and Q2 are changed to 68%, the time count T1 is changed to 1 and the time count T2 is changed to 0 respectively (S0001). The storage medium Y which is different from the storage medium 2 used in cases 2, 4, 5 is inserted in the disk reproducing device 1 (S0002). It is judged whether B/A≧P or not (S0003) and since B/A=75%, threshold P=70%, the values are returned to the initial set values such as the storage value Q1=70%, storage value Q2=0%, time count T1=0 and time count T2=0 respectively (S0004) and the video stored in the storage medium Y is reproduced (S0005).

Next, in case 3, the operation when B/A<Q1 in step S0008 will be explained. When the cleaning medium X is inserted (the second insertion counted from case 2), if B/A at the current time point becomes a value lower than the value of B/A stored in the storage value Q1 in case 1, there is a possibility that trouble may have occurred in the pickup unit 5 and other parts making up the disk reproducing device 1. Thus, it is judged whether an RF signal B is generated by the cleaning medium X or not first (S0012). When the maximum amplitude of the RF signal B is not 0, it is judged that dirt is produced on the disk itself and the process moves to step S3001 and operation similar to that in and after step S3001 in case 5 will be performed.

According to the disk reproducing device 1 constructed as shown above, the maximum amplitude of the RF signal generated when the inserted storage medium 2 is reproduced is compared with the maximum amplitude of a standard RF signal which has been stored beforehand, the state is judged against a predetermined threshold and it is possible to thereby automatically detect trouble in the pickup unit 5 or dirt on the pickup lens 51 without using any additional diagnostic part or diagnostic medium. Furthermore, by temporarily storing attenuation of the RF signal due to the dirt on the pickup lens 51 or the state of recovery every time the storage medium is loaded/unloaded, it is possible to report gradual actions to be taken to the user. Furthermore, since no additional members other than the microcontroller which is the control section 9 and a non-volatile medium used as the storage section 12 are necessary, it is possible to realize the dirt detection function of the pickup lens 51 at low cost.

The embodiment of the present invention has been explained in detail so far, but the present invention is not limited to the embodiment and can be modified in various ways within a range without departing from the essence of the present invention. For example, the threshold P is assumed to be 70%, but the threshold is not limited to this and may be changed according to the structure and construction of the disk reproducing device to which the present invention is applied. There will be no problem if various judgments are made in flow charts within a predetermined range under conditions that match the construction of the disk reproducing device to which the present invention is applied.

The effects of the present invention are as follows.

The disk reproducing device provided with a pickup lens dirt detection function according to the first aspect of the present invention comprises a pickup unit which is provided with at least a pickup lens for reproducing information stored in a storage medium, causes the storage medium to reflect a laser beam irradiated from the pickup lens and generates an RF (Radio Frequency) signal from the reflected laser beam, signal amplification means for amplifying the RF signal, storage means for storing a standard RF signal to be compared with the RF signal and various parameters such as a threshold, and control means provided with comparison/judgment means for comparing the RF signal and the standard RF signal for controlling the operation of the disk reproducing device, wherein it is judged whether the RF signal is attenuating or not based on the comparison value obtained from the comparison/judgment means and an alarm is displayed on a display section or display device when the comparison value falls below the threshold, and can thereby judge trouble with the pickup unit or the disk itself by means of the RF signal generated when the storage medium such as a disk is reproduced and realize a trouble detection function for the disk reproducing device or disk itself at low cost without requiring any special device.

The disk reproducing device provided with a pickup lens dirt detection function according to the second aspect of the present invention is the disk reproducing device provided with a pickup lens dirt detection function according to the first aspect of the present invention, wherein the disk reproducing device further comprises timer count means for temporarily storing the number of times the comparison/judgment means performs operation of judging attenuation of the RF signal and displays different alarms depending on the number of times judging operation is performed, and can thereby automatically present the user trouble elimination methods one by one to eliminate trouble causing attenuation of the RF signal.

The disk reproducing device provided with a pickup lens dirt detection function according to the third aspect of the present invention is the disk reproducing device provided with a pickup lens dirt detection function according to the first or second aspect of the present invention, wherein a comparison between the RF signal and the standard RF signal is made by comparing the gain widths when both frequency waveforms have maximum amplitude, and can thereby reliably judge attenuation of the RF signal.

The disk reproducing device provided with a pickup lens dirt detection function according to the fourth aspect of the present invention is the disk reproducing device provided with a pickup lens dirt detection function according to any one of the first to third aspects of the present invention, wherein the storage means stores display data or the like to OSD (On Screen Display) display an alarm message indicating dirt on the pickup lens and OSD-displays an alarm message on the display section or display device when the comparison value obtained by the comparison/judgment means falls below the threshold, and therefore the user can detect trouble such as dirt on the pickup lens by means of an alarm message automatically displayed in the middle of using the disk reproducing device without the need to examine the operation of the disk reproducing device for the user himself/herself, which improves convenience of the disk reproducing device for the user.

What is claimed is:

1. A disk reproducing device provided with a pickup lens dirt detection function comprising:
a pickup unit which is provided with at least a pickup lens for reproducing information stored in a storage medium, causes the storage medium to reflect a laser beam irradiated from the pickup lens and generates an RF (Radio Frequency) signal from the reflected laser beam;
signal amplification means for amplifying the RF signal;
storage means for storing a standard RF signal to be compared with the RF signal and various parameters such as a threshold; and
control means provided with comparison/judgment means for comparing the RF signal and the standard RF signal for controlling the operation of the disk reproducing device,
wherein it is judged whether the RF signal is attenuating or not based on the comparison value obtained from the comparison/judgment means and an alarm is displayed on a display section or display device when the comparison value falls below the threshold.

2. The disk reproducing device provided with a pickup lens dirt detection function according to claim 1, wherein the disk reproducing device further comprises timer count means for temporarily storing the number of times the comparison/judgment means performs operation of judging attenuation of the RF signal and displays different alarms depending on the number of times judging operation is performed.

3. The disk reproducing device provided with a pickup lens dirt detection function according to claim 1, wherein a comparison between the RF signal and the standard RF signal is made by comparing the gain widths when both frequency waveforms have maximum amplitude.

4. The disk reproducing device provided with a pickup lens dirt detection function according to claim 2, wherein a comparison between the RF signal and the standard RF signal is made by comparing the gain widths when both frequency waveforms have maximum amplitude.

5. The disk reproducing device provided with a pickup lens dirt detection function according to claim 1, wherein the storage means stores display data or the like to OSD (On Screen Display) display an alarm message indicating dirt on the pickup lens and OSD-displays an alarm message on the display section or display device when the comparison value obtained by the comparison/judgment means falls below the threshold.

6. The disk reproducing device provided with a pickup lens dirt detection function according to claim 2, wherein the storage means stores display data or the like to OSD (On Screen Display) display an alarm message indicating dirt on the pickup lens and OSD-displays an alarm message on the display section or display device when the comparison value obtained by the comparison/judgment means falls below the threshold.

7. The disk reproducing device provided with a pickup lens dirt detection function according to claim 3, wherein the storage means stores display data or the like to OSD (On Screen Display) display an alarm message indicating dirt on the pickup lens and OSD-displays an alarm message on the display section or display device when the comparison value obtained by the comparison/judgment means falls below the threshold.

8. The disk reproducing device provided with a pickup lens dirt detection function according to claim 4, wherein the storage means stores display data or the like to OSD (On Screen Display) display an alarm message indicating dirt on the pickup lens and OSD-displays an alarm message on the display section or display device when the comparison value obtained by the comparison/judgment means falls below the threshold.
